(19) United States
(12) Patent Application Publication
(10) Pub. No.: US 2014/0008229 A1
(43) Pub. Date: Jan. 9, 2014

(54) Method And Apparatus For Treating Tailings Using Alternating Current

(71) Applicant: DPRA CANADA INCORPORATED, Concord (CA)

(72) Inventors: Paul Garcia, Temecula, CA (US); Bruce S. Beattie, Vista, CA (US); Ben Harris, Fallbrook, CA (US); Doug Kimzey, Knoxville, TN (US); Robert C. Parrott, Knoxville, TN (US); James Micak, Aurora (CA)

(73) Assignee: DPRA Canada Incorporated, Concord (CA)

(21) Appl. No.: 13/765,924

(22) Filed: Feb. 13, 2013

(30) Foreign Application Priority Data
Jul. 9, 2012 (CA) 2782949

(51) Int. Cl. C02F 1/48

(52) U.S. Cl. CPC C02F 1/48
USPC 204/554

(57) ABSTRACT

There is a method described of treating tailings which are composed of at least some water and clay particles. Within the tailings, at least some water molecules are weakly bond to the clay particles to form a gel like fluid from which water does not readily separate. An alternating current is applied to the tailings to change the electro-chemical properties of the tailings to reduce the weak bonding between the water and the clay particles so that water within the treated tailings is able to separate. Water within the treated tailings is then allowed to separate without further application of electricity. In some embodiments, the treated tailings are allowed to separate through evaporation. Liquid tailings may also be treated with alternating current by applying alternating current to the liquid tailings at a voltage gradient range of 1 to 5 V/cm for a total duration of 24 to 300 hours. The application of alternating current may further comprise applying alternating current at a frequency of 1 to 30 Hz.

### FIELD OF THE INVENTION

This invention relates generally to the broad field of pollution control. More particularly, this invention relates to methods and apparatus that can be used to mitigate the persistent nature of certain types of tailings ponds, such as tailings ponds filled with waste products from tar or oil sand recovery processes and similar water bearing colloidal minerals in tailings suspensions from mining operations. Such mitigation allows land reclamation to occur.

### BACKGROUND OF THE INVENTION

Oil or tar sands are a source of bitumen, which can be reformed into a synthetic crude or syncrude. At present a large amount of hydrocarbon is recovered through surface mining. To obtain syncrude, the hydrocarbons must be first separated from the sand base in which it is found. This sand based material includes sands, clays, silts, minerals and other materials. The most common separation first step used on surface mined tar sands is the hot water separation process which uses hot water to separate out the hydrocarbons. However, the separation is not perfect and a water based waste liquid is produced as a by-product which may include small amounts of hydrocarbon, heavy metals, and other waste materials. The oil producers currently deal with what they call Fresh Fine Tailings (FFT) and Mature Fine Tailings (MFT); the distinction between the two being that MFT are derived from FFT after allowing sand to settle out over a period of typically 3 years. MFT are mostly a stable colloidal mixture of water and clay, and other materials, and is collected in onsite reservoirs called tailings ponds.

Oil extraction has been carried out for many years on the vast reserves of oil that exists in Alberta, Canada. It is estimated that 750,000,000 m³ of MFT have been produced. Some estimates show that 550 km² of land has been disturbed by surface mining yet less than 1% of this area has been certified as reclaimed. A 100,000 bbl/day production facility produces 50,000 tonnes per day of FFT, which is equivalent to approximately 33,500 m³ of FFT per day.

The FFT and MFT present three environmental and economic issues: water management, sterilization of potentially productive ore, and delays in reclamation. Although concentrations vary, MFT/FFT can typically comprise 50 to 70% water. This high water content forms, in combination with the naturally occurring clays, a thixotropic liquid. This liquid is quite stable and persistent and has been historically collected in large holding ponds. Very little has been done to treat the MFT that has been created and so it continues to build up in ever larger holding ponds. As development of the tar sands accelerates and more and more production is brought on line, more and more MFT/FFT will be produced. What is desired is a way to deal with the MFT/FFT that has been and will be generated to permit land reclamation, release of captured water and provide access to the productive ore located beneath such ponds.

MFT/FFT represents a mixture of clays (illite, and mainly kaolinite), water and residual bitumen resulting from the processing of oil sands. In some cases MFT may also be undergoing intrinsic biodegradation. The biodegradation process creates a frothy mixture, further compounding the difficulty in consolidating this material. It is estimated that between 40 and 200 years are required for these clays to sufficiently consolidate to allow for reclamation of tailings ponds. Such delays will result in unacceptably large volumes of MFT, and protracted periods of time before reclamation certification can take place unless a way to effect disposal and reclamation is found. The oil sands producers are required by a directive of the Energy Resources Conversation Board to treat their tailings to a bearing capacity of 5 kPa by 2012 and 10 kPa by 2015.

Applied electrical fields have been used to dewater soils for construction projects to improve bearing capacity. Electrophoresis has been used in many industries, such as the pharmaceutical industry and ceramics industry to produce high grade separations. Electrostriction has been used to create high density ceramics. In electrical resistance heating treatment at Fargo, N. Dak. (Smith et al., 2006)^{a}, electrostrictive phenomenon has been observed in the application of an electric field to already consolidated clays where the applied electric field ranged between 0.46 to 0.8 volt/cm. Examples of applications of electrical fields in various circumstances can be found in the following prior patents. ^{a} Smith, G. J., J. von Hatten, and C. Thomas (2006) Monitoring Soil Consolidation during Electrical Resistivity Heating. Proceedings of the Fifth International Conference on Remediation of Chlorinated and Recalcitrant Compounds, May 22-25, 2006, Monterey, Calif.,
U.S. Pat. No. 3,962,069
U.S. Pat. No. 4,107,026
U.S. Pat. No. 4,110,189
U.S. Pat. No. 4,170,529
U.S. Pat. No. 4,282,103
U.S. Pat. No. 4,501,648
U.S. Pat. No. 4,960,524
U.S. Pat. No. 5,171,409
U.S. Pat. No. 6,596,142

The application of electrical current to oil sands tailings has also been tried, as shown in U.S. Pat. No. 4,501,648. However, this teaches a small device with a tracked moving immersed electrode onto which is deposited clay solids. The electrode is moved out of contact with the liquid and then the solids are scraped off the electrode. A chemical pre-treatment step is required to achieve the desired deposition rate on the immersed electrode. While interesting, this invention is too small to be practical for MFT/FFT treatment and requires a chemical pre-treatment step which adds to the cost.

The application of electrical fields to treat small-scale clay deposits may not require efficient use of energy. However, on a large scale, the application of an electrical current requiring high power consumption or requiring an application of an electrical current over a long period of time may be prohibitively expensive or impossible to carry out due to the available resources. At remote sites, large-scale access to electrical power may be limited. Small variations in electrical current draws may have significant impact on costs and power requirements when dealing with millions of square meters of MFT and FFT.

Furthermore, in applications where electrical fields are used to treat tailings, such as through the application of direct current, contemporaneous water removal is often required. The removal of water during the application of an electrical field can be complicated and may require the application of a direct current electrical field for a long length of time or which uses a large amount of power, resulting in higher current draws and higher costs. In some cases, the application of electrical fields requires a two-step application of electrical current, first, to reduce the water content of the tailings and second, to increase the density of the partially treated tailings from which the water has been removed.

When water is removed contemporaneously with the application of the electrical field, the treated product may be difficult to extract from the treatment area, because it will have reached a high viscosity and high density during treatment, meaning it may be difficult to transport the material to a separate settling area.

What is desired is a better way to deal with vast volumes of MFT/FFT that will need to be treated. There is a need for a practical system for dealing with tailings efficiently and quickly. It is also desired to treat tailings with electrical fields without requiring contemporaneous removal of water from the tailings.

### SUMMARY OF THE INVENTION

In an embodiment there is a method of treating tailings having a combination of at least some water and clay particles, wherein at least some water molecules weakly bond to said clay particles to form a gel like fluid from which water does not readily separate. Alternating current is applied to said tailings to change the electro-chemical properties of said tailings to reduce the weak bonding between the water and said clay particles so that water within the treated tailings is able to separate. The water within said treated tailings is allowed to separate without further application of electricity. Once the treated material has dried, it will not perform like an expanding clay material again even if it is exposed to water. The treated material may dissolve if it is exposed to water, but the resulting solution will dry within a matter of days when exposed to air.

In another embodiment there is a method of treating liquid tailings through the application of alternating current. Liquid tailings having gel properties are treated with enough alternating current to disrupt the gel properties of the liquid tailings and to permit water to escape. The processed liquid tailings are air dried to produce a finished product in the form of a paste with a predetermined viscosity range.

In another embodiment there is a method of treating tailings having a combination of at least some water and clay particles, wherein at least some water molecules weakly bonds to said clay particles to form a gel like fluid from which water does not readily evaporate. The liquid tailings are treated with alternating current in which the alternating current is applied to the liquid tailings at a voltage gradient range of 1 to 5 V/cm for a total duration of 24 to 300 hours.

While not wanting to be restricted to any particular theory, it is believed that the application of the AC electrical field as described disrupts the persistent nature of the tailings. It may be that the current strength is enough to change the electrical properties of the clay particles, but there may be other process at work as well. The present invention is directed to the novel use of an applied AC current to change the ability of the tailings to hold water. Although certain specific examples are provided in this specification, in its broadest form any application of AC current that permits water to separate from the tailings is comprehended by the present invention.

### BRIEF DESCRIPTION OF THE DRAWINGS

Reference will now be made to preferred embodiments of the invention, by way of example only, with reference to the following figures in which:

FIG. 1a is a flow diagram of a method of treating tailings with alternating current;

FIG. 1b is a flow diagram of a method of treating tailings with alternating current including a transportation step;

FIG. 1c is a flow diagram of a method of treating tailings with alternating current including a mixing step;

FIG. 1d is a flow diagram of a method of treating tailings with a specified amount of alternating current;

FIG. 2 is a schematic of a system for treating tailings using alternating current;

FIG. 3 is a layout of electrodes in a three spot treatment pattern according to the present invention;

FIG. 4 is a schematic of a further electrode layout with a neutral pumping well according to a further aspect of the present invention;

FIG. 5 is a side perspective view of an arrangement of electrodes for applying alternating current to tailings;

FIG. 5a is a side view of an electrode in the embodiment of FIG. 5;

FIG. 6 is a side perspective view of power generation equipment for activating the electrodes in the embodiment of FIG. 5;

FIG. 7 is a side perspective view of the arrangement of electrodes for applying alternating current to tailings of FIG. 5;

FIG. 8 is a graph showing the relationship between the treatment time and power usage for different alternating current treatments of tailings;

FIG. 9 is a graph showing the shear strength of treated tailings when mixed with different amounts of sand;

FIG. 10 is a side perspective view of a small scale alternating current treatment system for tailings;

FIG. 11 is a perspective view of a larger scale alternating current treatment system for tailings;

FIG. 12a is a schematic drawing showing a configuration of electrodes for treating tailings;

FIG. 12b is a schematic drawing showing a configuration of electrodes for treating tailings;

FIG. 12c is a schematic drawing showing a configuration of electrodes for treating tailings;

FIG. 12d is a schematic drawing showing a configuration of electrodes for treating tailings; and

FIG. 13 is a schematic drawing showing a configuration of electrodes for treating tailings.

### DETAILED DESCRIPTION OF THE PREFERRED EMBODIMENTS

In this specification the terms MFT, or MFT/FFT or FFT shall mean the tailings that exist in tailings ponds that arise from the extraction of hydrocarbons, such as bitumen, from tar or oil sands, bauxite tailings ponds, fly ash tailings ponds, or other tailings ponds that are formed of a gel-like fluid which is a combination of at least some water and clay particles. As will be appreciated by those skilled in the art, the exact composition of MFT/FFT will vary, depending upon the composition of the ore being mined due to local variations in such ore. However, as used herein the term is intended to include compositions of material that include water, clays, silts, and in some cases residual hydrocarbons and hydrocarbon by-products among other things.

Canadian Patent Application No. 2,736,675, entitled “Electrokinetic Process and Apparatus for Consolidation of Oil Sands Tailings”, filed Apr. 7, 2011, Canadian Patent Application No. 2,758,872, entitled “Electrokinetic Process and Apparatus for Consolidation of Oil Sands Tailings”, filed Nov. 16, 2011 and U.S. patent application Ser. No. 13/440,386, entitled “Electrokinetic Process and Apparatus for Consolidation of Oil Sands Tailings”, filed Apr. 5, 2012, (“the previous patent applications”) each incorporated herein by reference, describe the application of electric fields to tailings ponds by inducing flocculation of particles in the tailings and releasing water from the tailings during the application of an electrical field and compacting the flocculated solids and removing further water released from the compacting solids to create a compacted material having a minimum desired load bearing capacity.

The process described in the previous patent applications include the step of removing water from the MFT/FFT prior to further compacting and settling of the tailings. Moreover, as described in those previous patent applications, the highest power draw occurred during the water-removal step. During this period, the pH at the anode decreases and the low pH water was being electro-osmotically drawn through the MFT to the cathode. This resulted in the release of water from the MFT. It was disclosed that electro-osmotic flow occurs at voltage gradients ranging from 1 to 2 V_{DC/cm}. Electrostriction occurs at voltage gradients of 2 V_{DC/cm} and higher. From the perspective of compacting the MFT, it was considered that there was little benefit in doing compaction where the water content was high.

The present patent document describes a method of treating tailings which does not require a water removal step during the application of alternating current.

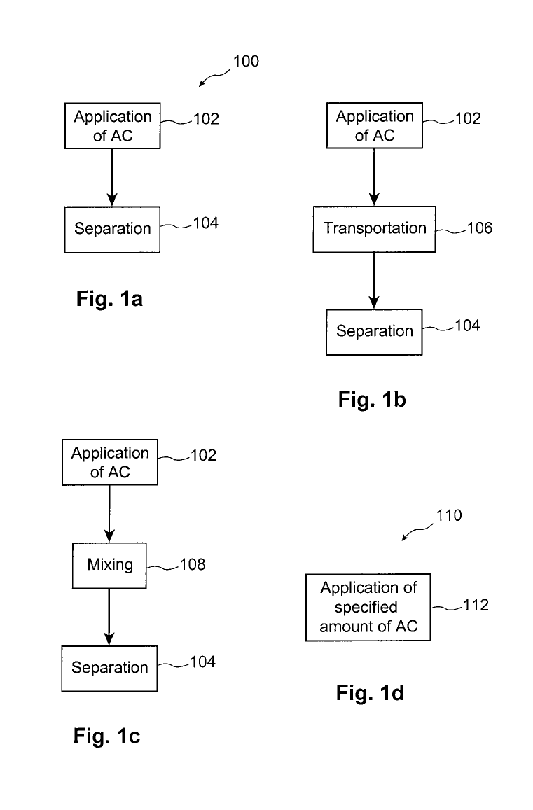

As shown in FIG. 1a, there is a method of treating tailings 100. The tailings have a combination of at least some water and clay particles. At least some water molecules are weakly bonded to the clay particles to form a gel like fluid from which water does not readily separate. At 102, alternating current is applied to the tailings to change the electro-chemical properties of the tailings to reduce the weak bonding between the water and said clay particles so that water within the treated tailings is able to separate. At 104, the water within the treated tailings is allowed to separate without further application of electricity.

The application of alternating current at 102 may comprise the application of alternating current at a voltage range of 1 to 5 V/cm for a total duration of 24 to 300 hours. In a preferred embodiment, the application of alternating current at 102 may comprise applying alternating current at a voltage range of 3 to 5 V/cm for a total duration of 24 to 48 hours. In a most preferred embodiment, the application of alternating current at 102 may comprise applying alternating current at about 4 V/cm.

The application of voltages greater than 5V/cm is an inefficient use of electricity because the electro-chemical changes induced by the application of more than 5V/cm do not provide additional benefits beyond those benefits which result from lower voltages applications. However, although possibly a waste of electricity, applications of greater than 5V/cm nonetheless can be effective in introducing the desired electro-chemical changes in the tailings and thus are comprehended by the present invention.

Testing has shown that for applications of 4V/cm of alternating current in batches of between 5 L-20 L of oil sands tailings, electrochemical changes to the tailings were first observed after approximately 24 hours and continued until approximately 48 hours. The electrochemical changes observed do not vary due to relation to the volume of tailings treated, although the energy required for those treatments will increase for higher volumes of tailings. Based on these tests, the application of 4V/cm for 48 hours is understood to cause the desired electro-chemical changes in the treated tailings. It is also understood that the length of treatment and the voltage gradient applied can be varied depending on the desired properties of the final product. As is discussed in more detail below, for example, a longer application of voltage can be used to create a final product with higher shear strength. The application of 4V/cm for 96 hours of treatment will result in a final product, after water has been separated from the tailings, that has very high shear strength with a brick-like consistency. Although a solid brick may have uses for certain applications, many companies owning FFT/MFT want to treat those tailings so as to meet the minimum requirements for disposal with the least amount of energy required. For example, Directive 74 of the Energy Resources Conservation Board in Alberta requires shear strengths of 5 kPa and 10 kPa for disposal. The compaction seen after treatment for 96 hours can far exceed the requirements set out in directive 74 and may not be desired by companies dealing with MFT/FFT.

Applying alternating current for shorter periods of time, such as 48 hours, can result in treated tailings that can be transported away from the treatment location in a paste form, which can then be left to air dry, for example, into a more viscous or solid material.

The electro-chemical changes created through the application of alternating current results in compaction of treated material equal to or greater than required by Directive 74. Once the tailings have dried after being treated according to the present invention it appears that they will not perform like an expanding clay. Depending on the level of treatment, the material may dissolve in water, but tests have shown that the resulting solution will again dry within a matter of days. It is understood that this process results from the electrokinetic process where the material thickness is reduced in the direction of the applied electric field.

In the previous patent applications discussed above, flocculation was described as occurring at voltages of 1-2 V/cm whereas electrostriction occurred at high voltages of above 2V/cm. In those patent applications, the application of voltage was increased as water was removed and the flocculation step occurred prior to the electrostriction step. In the present patent document, changes in the electrochemical properties can be induced through an initial application of 4V/cm of alternating current. There is no need to perform the initial step of removing water from the tailings at a lower voltage. Although the voltage may be increased during the application of alternating current, it is possible to begin treatment at an initial value of around 3-5 V/cm and maintain the voltage at that level throughout the treatment. It appears that no separate flocculation and electrostriction steps are required.

The application of alternating current at 102 may further comprise applying alternating current at a frequency of 1-30 Hz. In a preferred embodiment, the application of alternating current at 102 further comprises alternating current at a frequency of 10-20 Hz. The application of alternating current at a frequency of greater than 30 Hz in initial testing has resulted in higher power consumption with no apparent improvement in treatment results. Testing has shown that applications of alternating current at a frequency range of 15-20 Hz are particularly effective on oil sands tailings. However, it will be understood that other materials may require other frequency ranges which are comprehended by the present invention.

In some applications, during the separation of the water at 104, the water within the treated tailings may be allowed to separate by allowing the treated tailings to dry through evaporation. Drying by evaporation may result in lower power costs than for applications where electricity is applied during water removal. The separation step 104 may also occur through other means, including through the application of pressure, through the use of a filter, drain or wick, or through the application of an additional electrical current, so long as water is allowed to escape from the tailings. In the field, the tailings may be treated and allowed to air dry on site without being transported to a separate treatment area.

In contrast to tailings treated by alternating current, untreated tailings which are left in the open air do not consolidate. Even after 48 hours of being left in open air, untreated tailings remain in a gel-like state and do not release water.

Applying alternating current to the tailings without initially removing water ensures that “dry-out” does not occur where electrical contact is lost with the electrodes during the application of electrical current. By bypassing the water removal step, an additional benefit is that water removal equipment is not required. The electrodes can be placed directly in the medium and there is no requirement for a water jacket around the electrodes. Overall, less water management is required when the water is allowed to naturally evaporate independently from the application of electrical current.

As shown in FIG. 1b, at 106, an additional step of transporting the treated tailings to a site for further disposal occurs after the application of alternating current 102 and prior to the separation step 104. The disposal site may be a settling pond or a treatment facility where settling of the treated tailings can occur. The treatment of tailings without removing excess water allows for the transportation step to occur before full consolidation. After the treated tailings have been allowed to air dry, the final product cannot be as easily transported. If the treated tailings have an end use that requires a predetermined viscosity or shear strength, an additional mixing step may also be performed.

As shown in FIG. 1c, after the separation of water at 104, the treated tailings can be mixed at 108 with a predetermined amount of filling material prior to evaporative drying of the tailings to produce a desired shear strength for the processed material. In one embodiment, the filler material is sand. In an embodiment, the desired shear strength is greater than 5 kilopascals.

Direct current can be applied to the tailings at any point during the treatment process to increase the rate at which water is removed from the tailings. For example, direct current can be applied to the tailings during the application of alternating current to enhance water removal. Applying a direct current offset with the application of alternating current may increase the amount of water removal than without the direct current offset. Although not necessary, the application of water removal through a DC offset can allow for speedier water removal, which can result in reduced treatment time. Moreover, the application of a DC offset may allow the treated tailings to act like a battery and hold an electric charge. Once the DC offset has been removed, tailings will continue to hold a charge which will continue to allow water to be removed.

In an embodiment, the application of alternating current 102 may comprise treating liquid tailings having gel properties with enough alternating current to disrupt the gel properties of the liquid tailings and to permit water to escape. The separation step 104, may comprise air drying the processed liquid tailings to produce a finished product in the form of a paste with a predetermined viscosity range. The predetermined viscosity range may be any amount higher than the original viscosity of the tailings. In most cases, the viscosity of the untreated tailings will be in the range of 0 to 5,000 centipoise. The paste may have a viscosity of between 100,000 and 1,000,000 centipoise.

During application of alternating current 102, specific gravity values increase with treatment time. Specific Gravity (SP) is the ratio of substance at a given volume and temperature to water at the same volume and temperature. Values greater than one are denser than water and vice-versa. In some embodiments, starting MFT SP values are 1.25, 1.26 @ 8 hrs of AC treatment, 1.28 @ 16 hrs of AC treatment. For most applications of alternating current, the SP range would be from 1 to 1.5 for the duration of the treatment.

In an embodiment shown in FIG. 1d, there is a method 110 of treating tailings through the application of a specified amount of AC 112. The tailings are a combination of at least some water and clay particles. At least some water molecules are weakly bonded to the clay particles to form a gel like fluid from which water does not readily separate, such as through evaporation. The liquid tailings are treated with alternating current by applying alternating current to the liquid tailings at a voltage range of 1 to 5 V/cm for a total duration of 24 to 300 hours. Following the treatment of the tailings, in an embodiment similar to that disclosed in FIG. 1b, further treatment of the tailings may be provided by transporting the liquid tailings to a separate drying location after treating the liquid tailings with alternating current. The treated tailings may then be air dried at the separate drying location to form a finished product. The finished product may have a shear strength greater than 5 kilopascals (kPa). In a preferred embodiment, the finished product may have a shear strength greater than 10 kPa.

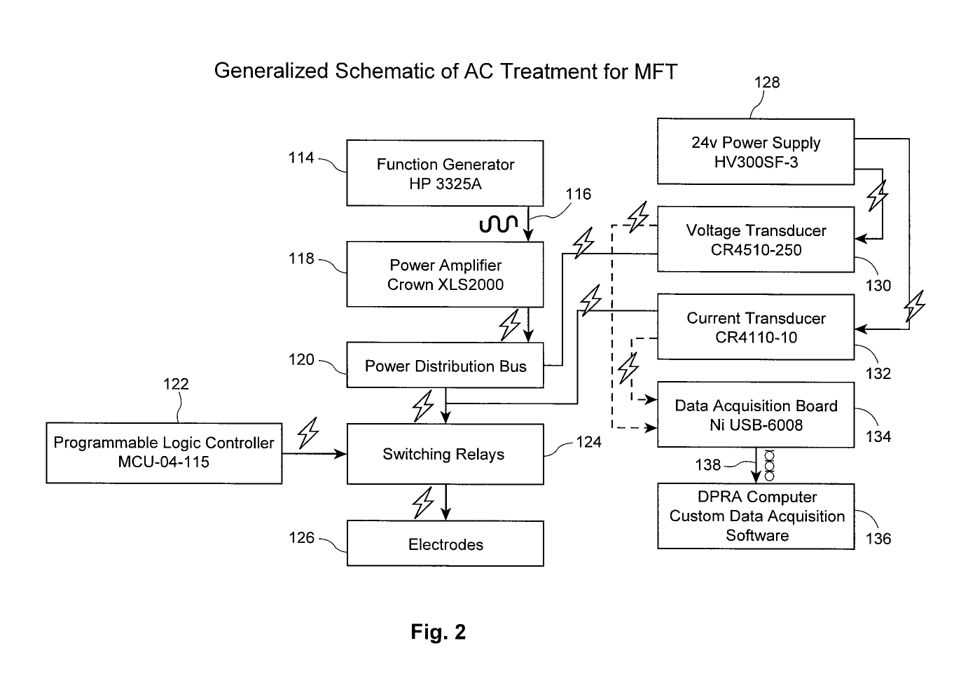

FIG. 2 shows a schematic of an embodiment of equipment which may be used to perform AC treatment of tailings. A function generator 114 is used to generate a Sine Wave signal 116. The Sine Wave 116 may have a frequency ranging from 0 to 50 hz at 10v. The signal 116 is then amplified by a power amplifier 118 to a specific level in order to provide the desired voltage gradient (v/cm) between electrodes 126. The amplified power is then transmitted to a power distribution bus 120 and switching relays 124. The electrodes 126 are powered by the switching relays 124 which are triggered by an input signal generated by the Programmable Logic Controller 122. Voltage transducer 130 and current transducers 132 capture their respective signals. Signals from the voltage transducer 130 and current transducer 132 are converted from an analog signal to a digital signal 138 via a Data Acquisition Board 134. The Digital signal 138 is sent from the acquisition board to a processor 136 where the voltage is logged using custom software.

In an embodiment, the components of the schematic may have the following model numbers;

| | |
|---|---|
| Function generator 114 | HP 3325A |
| Power Amplifier 118 | Crown XLS2000 |
| Programmable Logic Controller 122 | MCU-04-115 |
| Power Supply (24 v) 128 | HY3005F-3 |
| Voltage Transducer 130 | CR4510-10 |
| Data Acquisition Board 134 | Ni USB-6008 |

Although these model numbers provide examples of devices that can perform the functions of each of the components above, various different types of products can provide the same function. For example, the processor may be any type of machine, whether virtual or physical, that can provide analysis of the collected data. Moreover, different configurations of components may be used to apply alternating current to the tailings so long as alternating current is applied which allows for the gel properties of the tailings to be disrupted which allows for water to escape the tailings.

The application of alternating current through the electrodes can be varied in frequency and time to ensure that the electrodes do not overheat. Not all the electrodes need to be on at the same time, and pairs of electrodes can be activated at different times. Various arrangements of electrodes may be used and the electrodes can be turned on for various lengths of time. For example, the electrodes may alternate between which is the anode and which is the cathode every three minutes. If there are a network of electrodes, for example, in a hexagonal configuration, the electrodes which are on can be switched every 20 minutes in a clockwise or counterclockwise pattern. Corrosion buildup and plating of minerals can be reduced by alternating the cathodes and anodes during application of the alternating current. In some embodiments, the equipment may be mounted on a mobile device so that alternating current can be applied directly on site at a tailings pond.

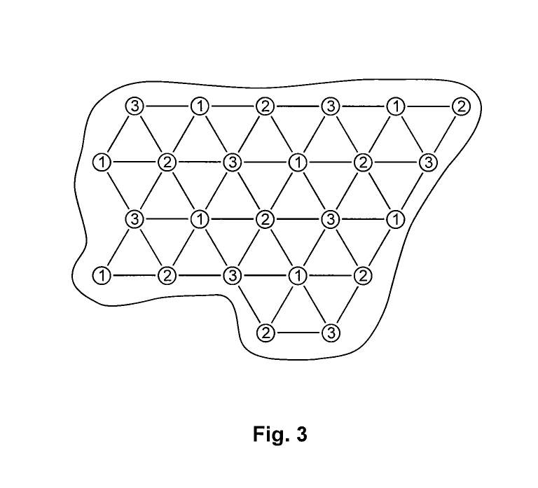

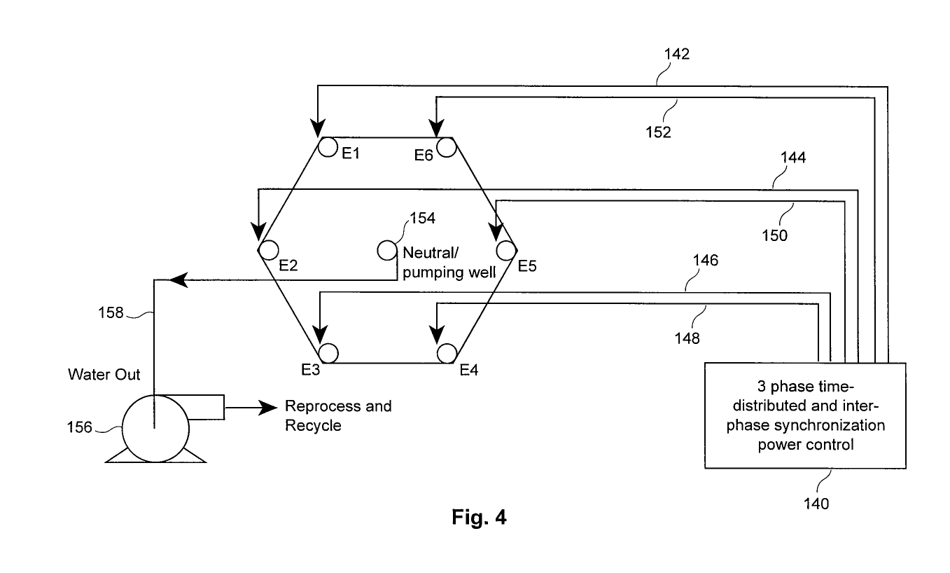

One apparatus used to effect the action of the present invention on MFT/FFT is described below. One embodiment of this invention involves the use of a variable voltage power supply connected to a network of electrodes. Where the power source is an AC source, the electrodes are arranged in a triangular (FIG. 3) or hexagonal pattern (FIG. 4). Other configurations of electrodes are also possible as long as the application of alternating current allows the water and clay particles in the tailings to separate. In FIG. 3 there are three electrodes denoted with the numbers 1, 2, or 3. These electrodes would be charged out of phase with one another, with the phase charge varying with time. According to the present invention, the spacing between electrodes and the desire voltage gradient is determined through the desired degree of consolidation and time to achieve, the volume and geometry of the treatment volume, and the capability of the power supply.

FIG. 4 shows an embodiment of an apparatus for applying an electrical field to induce a voltage gradient across the area to be treated, or subsections of the area to be treated. There are six electrodes shown as E1 to E6 respectively in a regular hexagonal pattern. A source of AC power 140, is shown and connected by electrical conductors 142, 144, 146, 148, 150 and 152 to each electrode in turn. As will be understood by those skilled in the art, each of the electrodes E1 through E6 will be charged at 60 degrees out of phase with the adjacent electrode, with the phased charging varying with time. This results in a maximum electrical field being generated across the long diagonals of the hexagon (e.g. E1 to E4), where the electrodes are 180 degrees out of phase (Note: Electrodes E2 to E5 are also 180 degrees out of phase, as are electrodes E3 to E6, and so on).

The AC power source 140 will be provided with a power controller to permit the voltages being applied to be varied. Most preferably it provides a six phase for the hexagonal geometry and a three phase time distributed and interphase synchronization power control for the three phase geometry. The voltages applied are to be determined based on the most economic use of electrodes (number and spacing) the capabilities of the power supply, but the hexagonal pattern is believed to provide good results (for illustration of an AC application where the volume of MFT to be treated has simple geometry approximating a cylinder); and, the timing of the water release from the MFT/FFT and the subsequent increase in electrical resistance. The desired voltage supplied by the transformer is dependent on the spacing of the electrodes, and the conductivity of the interstitial water in the MFT/FFT. The present invention contemplates that the transformer will be kept in a safe locked housing and operatively connected to a portable computer with remote access communication features, such as for example through a cellular network communications grid. This combination permits remote monitoring and access to operate the system.

According to a further aspect of the present invention, the electrical field generating equipment will include the capability of monitoring the electrical conductivity throughout the treatment area.

Also shown is an optional neutral electrode 154 located at the center of the hexagonal spacing of the electrodes. According to one embodiment of the invention this electrode can also function as a water recovery device. In this case a pump 156 is used to draw the water out of the hexagon, through a conduit 158. This water includes water that is freed from the MFT/FFT during the application of a DC offset. The reclaimed water can then be optionally treated and recycled as desired using conventional water treatment processes if desired.

According to one aspect of the present invention, these electrodes E1 to E6 can be constructed using steel pipe, steel rods, sheet metal pile, electrically conductive plates suspended on electrical cable or any other electrically conductive or electro-magnetic material. For in situ treatment, the electrodes are placed in position by either through driving, drilling, using conventional drilling equipment, pile driving equipment, or in the case of treatment cells specifically constructed for this purpose, placed in accordance with the design placement with the MFT/FFT pumped into the treatment cell.

Continuous Treatment System

Another aspect of the invention is the use of pipes with electrodes built into them that transport tailings material to be treated. While material transits the pipe, it will be treated continuously via either alternating or direct current or some combination of both to render a treated material when the material exits the pipe. After exiting the pipe, the treated material may then be allowed to separate water without further application of electricity current, for example, by allowing the treated material to air dry. In other embodiments, the material may be allowed to separate water during transit through the pipe. In a further embodiment, the treated material may constitute a disposable material that meets the requirements for shear strength required under Directive 74.

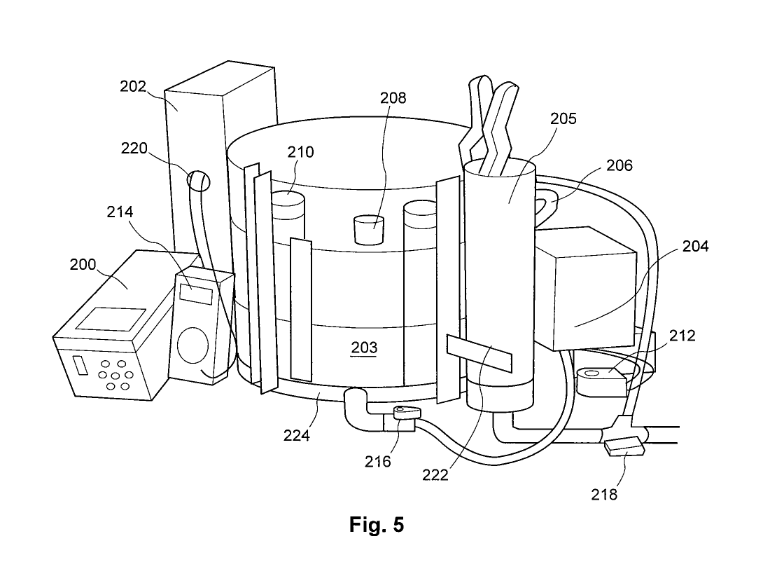

An exemplary experimental apparatus for treating tailings with alternating current is shown in FIGS. 5-7.

An electrode switching controller 200 is connected to unit 202 which includes switching relays, a power distribution bus and a transducers enclosure. The switching relays in unit 202 are connected to the electrode assembly 210 through electrode power distribution cabling 220. The electrode assembly 210 is placed in a tailings treatment container 203. A multimeter 214 can be used to measure the voltage output to the electrode assembly 210. For example, in an application where a voltage gradient of 4V/cm is applied to the tailings and for electrodes which are spaced by 19 cm, the multimeter will display a voltage of 76 V.

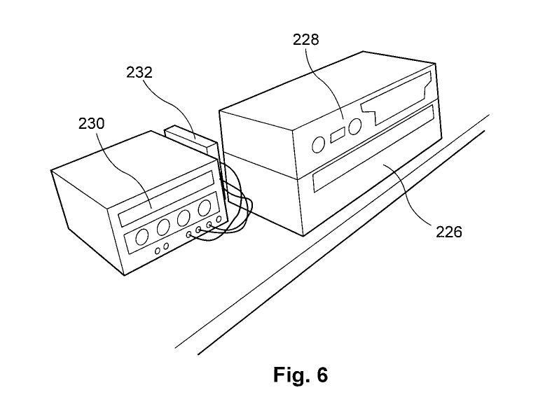

The system shown in FIGS. 5-7 includes a water management system. A hydraulic system water reservoir 204 collects water which is released from the container 203 through a slow process into the water collection sump 224. Water collected in the container 203 drains through vertical drain 208 into the sump 224. Water collected in the sump 224 exits through the water collection sump cleanout valve 216 and can be pumped into the reservoir 204 by activating a peristaltic pump 234 (FIG. 7). Water collected into the reservoir 204 then cycles through to the electrode assembly 210. The peristaltic pump 234 can be activated manually. Low levels of water in the container 203 can be detected by the water level switch 222 in the sight gauge 205. The sight gauge 205 forms a closed fluid loop with the electrode assembly 210. The sight gauge 205 is connected by a pipe to a water level activated valve 212 and a hydraulic system priming diverter valve 218. The water level activated valve 212 is in electrical connection with a water level switching relay 236. Power is connected to the water level switching relay 236 (FIG. 7). The water level switch 222 is what turns power on and off to the relay 236 (FIG. 7). When the water level switch 222 turns on, it turns on the valve 212 which fills the reservoir 204. A hydraulic system manifold 206 connects the sight gauge 205 to the 7 electrodes in the electrode assembly 210.

FIG. 5a shows a single electrode 210a from the electrode assembly 210 of FIG. 5. An electrode power connection terminal 238 provides power to the electrode. Hydraulic water level management tubing 240 provides a connection between the electrode and hydraulic system manifold 206 (FIG. 5). The electrode power connection terminal is connected to a graphite electrode rod 242, which is surrounded by perforated acrylic tubing 244. A geotextile filter fabric 246 is placed over the perforated acrylic tubing 244. An insulating rubber foot 248 is connected to the base of the electrode 210a of FIG. 5a.

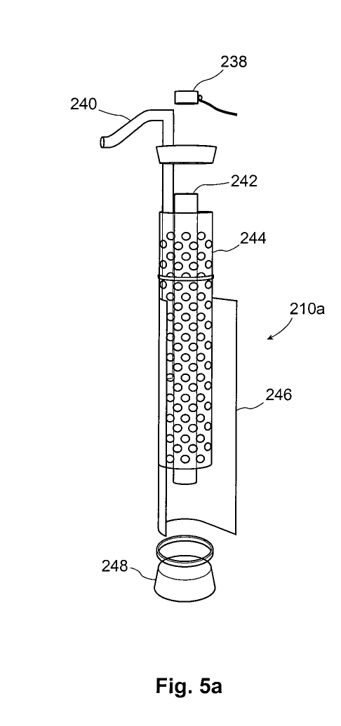

As shown in FIG. 6, a function generator is in electrical connection with a power amplifier 228. The power amplifier 228 is in turn connected to the power distribution bus in unit 202 (FIG. 5). A transducer power supply 230 provides power for a voltage transducer and a current transducer which both are contained within the transducer enclosure of unit 202 (FIG. 5). A data acquisition device 232 collects data from the voltage transducer and current transducer of unit 202 (FIG. 5). One method of operating the various components described in FIG. 6 is set out in general terms in FIG. 2.

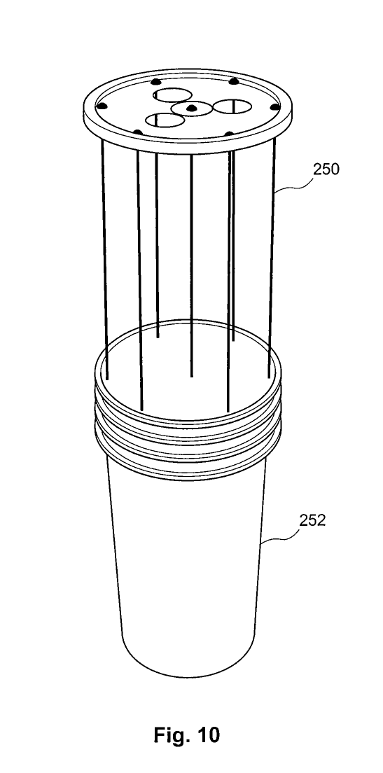

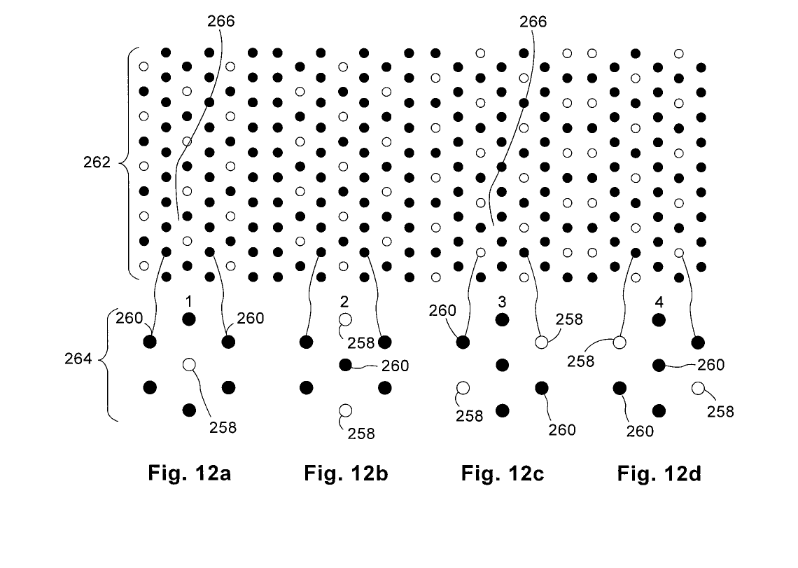

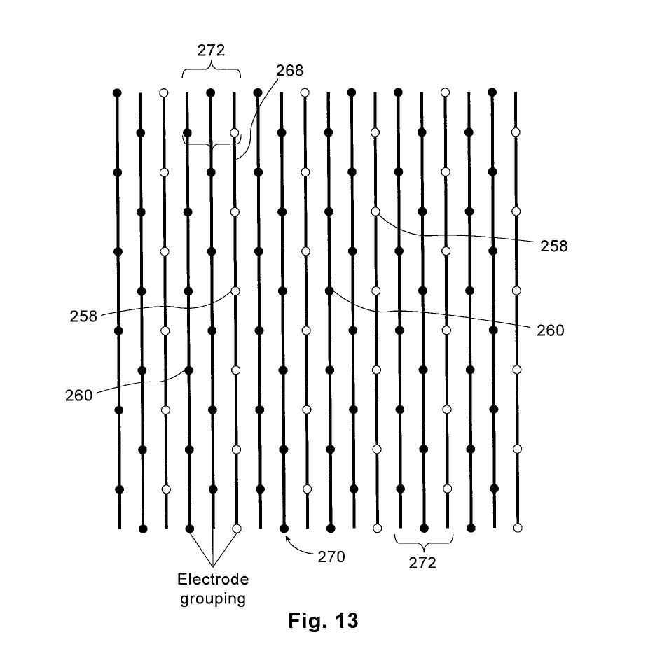

In FIG. 10, a simplified apparatus for applying alternating current is shown. A series of electrodes 250 are placed into a pail of tailings 252. The electrodes 250 may, for example, be made of stainless steel or other material that is capable of conducting alternating current effectively. In this example, water removal is not required during the application of electrical current. Following the application of the electrical current, the pail 252 may be emptied at a location where water separation of the treated tailings may occur. As has been discussed above in relation to FIGS. 3 and 4 and as is discussed in further detail below in relation to FIGS. 12a-12d and 13a-13c, various different configurations of electrodes may be applied during the application of alternating current. Moreover, which electrodes are anodes and cathodes can be varied during the application of alternating current and, for example, may be cycled through specific time intervals, such as 5 minute intervals. In alternating current applications the time between cycles of arrangements of cathodes and anodes is not as restricted as it is for direct current applications. Where flocculation is induced through the application of direct current, water is removed through migration of acidic water from the anode, which takes time. The application of alternating current does not require water migration, and therefore maintaining the orientation of the same cathodes and anodes for a longer period of time is unnecessary.

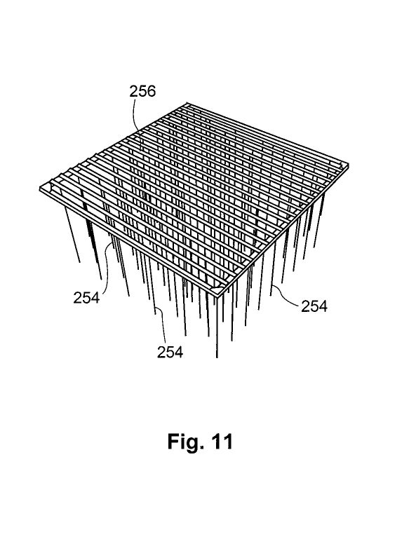

FIG. 11 shows a larger scale application similar to the example in FIG. 10. Electrodes 254 are connected to a rack 256. The rack 256 may be lowered into a tailings pond or container in a large scale treatment facility for applications of alternating current. Various sizes of racks 256 and electrodes 254 are possible. Electrical connections to an apparatus for controlling the alternating current through the electrodes are not shown in FIG. 11. However, it is to be understood that any electrode configuration, such as that disclosed in FIG. 2, may be used to control the activation of the electrodes in FIG. 11. In one embodiment, the electrodes may be made of stainless steel which may be connected to the aluminum rack using bolts. Other materials and connection means may be used to construct and connect the various components.

FIG. 12a-12d shows one configuration of anodes and cathodes for various designs of electrodes as comprehended by the present invention. Electrodes shown with a line through them represent anodes 258 and black electrodes represent cathodes 260. Each of the FIGS. 12a-12d shows a generalized structure in a rectangular format labeled as 262 that includes within it hexagonal electrode configurations, an example of which is outlined in grey lines 266 and is shown separately in the blown-up hexagonal formation labeled as 264. The configuration shown in FIGS. 12a-12d can be applied to both hexagonal electrode configurations, such as shown in FIG. 10, and to rectangular racks, such as shown in FIG. 11. The concepts of switching anodes and cathodes can equally apply to other formations of electrodes.

FIGS. 12a-12d show one of many possible examples of a variable activation of anodes and cathodes that varies over time. In the hexagonal formation of FIG. 12a, the central electrode is an anode 258 and the six exterior electrodes are cathodes 260.

As shown in FIG. 12b, looking at the hexagonal formation 264, the upper most and lower most electrodes are anodes 258, and the other electrodes are cathodes 260.

As shown in FIG. 12c, looking at the hexagonal formation 264, the upper right and lower left electrodes are anodes 258 and the other electrodes are cathodes 260.

As shown in FIG. 12d, looking at the hexagonal formation 264, the upper left and lower right electrodes are anodes 258 and the other electrodes are cathodes 260.

In one embodiment, the electrodes will rotate through the cycles shown in FIGS. 12a-12d, in five minute cycles.

FIG. 13 shows another example of a system for variably activating anodes and cathodes of a large-scale electrode structure for applying alternating current to tailings. As shown in FIG. 13, the electrodes may be grouped into segments 270 which are each connected to the same electrical source represented by line 268. Conceptually, the system shown in FIG. 13 consists of a repeating pattern of three segments 272. Each segment 270 will either be all cathodes or all anodes. In turn, one of the three segments will be entirely anodes 258, while the other two segments are entirely cathodes 260. The selection of electrodes which are anodes can be switched between the three segments, so that at the completion of a cycle, each of the three segments will have been anodes once during that cycle. By grouping the electrodes into segments as shown in FIG. 13, it will be easier to manage the switch between anode to cathode, because each electrode will not need to be switched individually. Grouping the anodes and cathodes in this way will reduce the amount of equipment required.

Testing Parameters

Various tests of AC parameters have been performed with a focus on minimization of power consumption, reduction of time to treat, where practical, and the optimization of the composition of treated material. Ideally, the end product would be an electrostricted paste that could be blended with sand into various composite sand blends suitable for reclamation disposal and desired end uses for industry. Three tests were performed, described as AC-1, AC-2 and AC-3.

For AC-2 and AC-3, electrodes were packed with pea gravel, displacing water column, to reduce current draw demands and floor of test tank raised with pea gravel to better accommodate smaller treatment volumes and drains were vented via the water collection sump 214 (FIG. 5) with an exhaust fan creating negative pressure to aid in moisture/water removal.

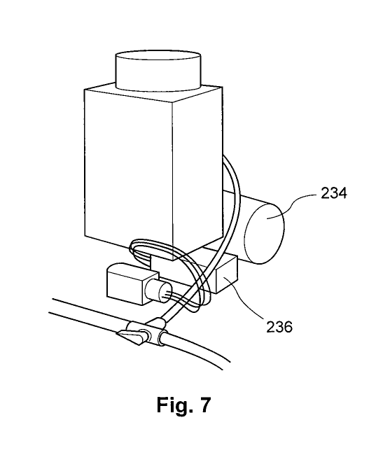

FIG. 8 shows batch treatment parameters and results for tests AC-1, AC-2 and AC-3, described in more detail below. The electrode placement used for the AC-1, AC-2 and AC-3 tests are shown in FIG. 5.

### AC-1 Operation Parameters:

Electrode power and polarity configuration changes every 12 hours with full rotation every 48 hours;

Voltage step ups of 1V/cm, 2V/cm, 3V/cm and 4V/cm every 48 hours for total run time of 192 hours;

Frequency was 30 Hz;

20 Liters FFT

Power use: 7.32 kWh per liter treated or 366 kWh per m³ (assuming linear scale up).

For AC-1, the properties of increased undrained shear strength over a total 30 hours of air drying resulting in unconfined compressive strength of 49.2 kg/cm2 or 4,826 kPa.

Following the alternating current treatment in AC-1, the sample was sent in a sealed contained to an additional testing facility where the following report was prepared.

### Strength Testing Report

The sealed container was opened and the sample was visually observed. An attempt was made to test the sample with a pocket penetrometer. The sample was too soft to test with the pocket penetrometer.

Hand-held vane testing was performed and it showed undrained shear strength of 0.1 kg/cm² (19.6 kPa). The sample was highly plastic and exhibited characteristics that are not typical of soils.

The sample was left in an open pan and allowed to air dry. The pocket penetrometer and vane shear testing was done periodically, but no changes were observed for the first 7 hours of observation.

After about a total of 20 hours of air drying, the sample was observed to be hard. The pocket penetrometer resulted in a very high unconfined compressive strength of 32 kg/cm² (3,136 kPa). Further air drying (total of 30 hours) resulted in unconfined compressive strength of 49.2 kg/cm² (4,826 kPa). Additional air drying resulted in high strength which made measurements with the pocket penetrometer impossible.

### AC-2 Operational Parameters:

Electrode power and polarity configuration changes every 12 hours with full rotation every 48 hours;

Voltage step ups from 1V/cm to 4V/cm after 48 hours for total run time of 96 hours;

Frequency was 30 Hz; DC offset 10 V;

10 Liters MFT;

Power use: 1.65 kWh per liter treated or 165 kWh per m³ (assuming linear scale up).

### AC-3 Operational Parameters:

Electrode power and polarity configuration changes every 3 hours with full rotation every 12 hours;

Voltage commenced at 4V/cm for 24 hours then to 5V/cm for 12 hours to determine any additional treatment value at this higher current for a total run time of 36 hours;

Frequency was 30 Hz; DC offset 10V;

10 Liters MFT;

Power use: First 24 hours at 4V/cm was 1.51 kWh per liter treated; next 12 hours at 5V/cm was 1.60 kWh per liter treated for a combined total of: 3.11 kWh per liter treated or 311 kWh per m³ (assuming linear scale up).

For the AC-3 test, there was no measureable value of increasing the voltage to 5V/cm for the final 12 hours of the test. However, considering the reduced time from 96 hours (AC-2) to 36 hours (AC-3) at the expense of increased power consumption, the increased cost of power for the shorter period may justify the expense as it more than doubles the potential through-put for batch fixed assets.

### Treated Material in Sand Various Composition Testing

For AC-3 treated material, a representative comparative series of mixing tests was prepared with sand to measure unconfined shear strength using a hand-held shear vane tester.

The purpose of performing these mixing tests was to determine what effect various sand to treated material mixing ratios had on the drying time and unconfined shear strength of the samples.

### Testing Procedure

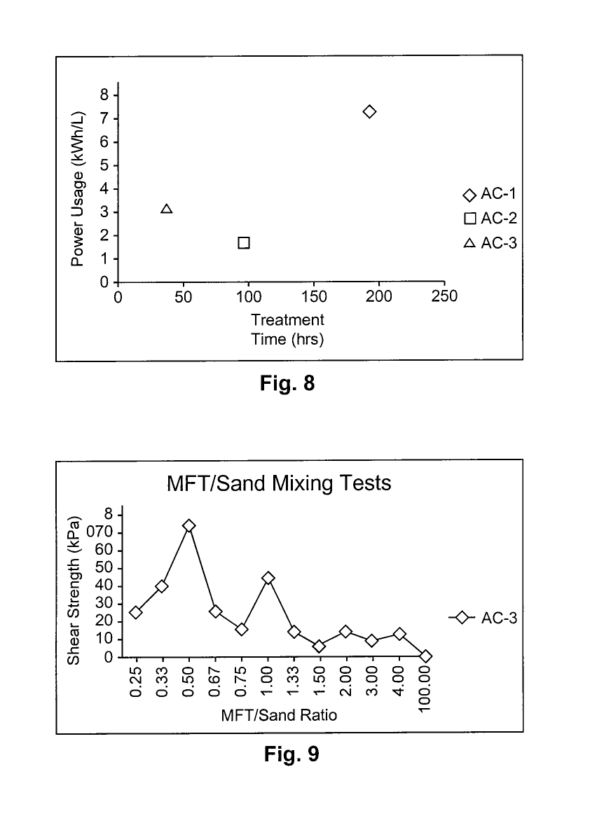

1) Approximately 500 ml of treated MFT material was stirred for approximately 2 minutes to produce a homogeneous paste-like material.
2) A disposable paper tray was placed on a food scale (accurate to 0.1 oz) and the scale was zeroed.
3) Approximately 1 tablespoon of treated MFT was placed in the paper tray and weighed. 1 tablespoon of treated MFT weighed 1.1 oz.
4) Approximately 1 tablespoon of sorted dry play sand was weighed using the same process as outlined in Step 3. 1 tablespoon of sand weighed 0.8 oz
5) Based on the mixing ratios presented below, each sample was placed in dedicated paper trays with the volumes of each material calculated by their respective weights.
6) Samples were mixed for approximately 1 minute until the consistency was homogenous
7) After 24 hours had elapsed, the unconfined shear strength of each sample was approximated using a handheld pocket shear vane tester (results presented below in Table 1 and in FIG. 9).
8) After 96 hours, samples were visually examined to log overall sample consistency and relative dryness (results presented below in Table 1).

TABLE 1

| Sample | MFT | Sand | Mixing | kPa | Consistency |
|---|---|---|---|---|---|
| ID | (Tbsp) | (Tbsp) | Ratio | (24 hrs) | (96 hrs) |
| A | 1 | 0.01 | 100 | 1 | Solid |
| B | 1 | 1 | 1 | 45 | Dry, Brittle |
| C | 1 | 2 | 0.5 | 75 | Dry, Brittle |
| D | 1 | 3 | 0.33 | 40 | Dry, Brittle |
| E | 1 | 4 | 0.25 | 25 | Dry, Brittle |
| F | 2 | 1 | 2 | 14 | Dry, Brittle |
| G | 2 | 3 | 0.67 | 25 | Dry, Brittle |
| H | 3 | 1 | 3 | 8 | Slightly Moist, |
| | | | | | Brittle |
| I | 3 | 2 | 1.5 | 5 | Slightly Moist, |
| | | | | | Brittle |
| J | 3 | 4 | 0.75 | 15 | Slightly Moist, |
| | | | | | Brittle |
| K | 4 | 1 | 4 | 12 | Slightly Plastic |
| L | 4 | 3 | 1.33 | 14 | Slightly Plastic |
| M* | 4 | 12 | 0.33 | 15 | Moist, Brittle |

*Sample M has the same mixing ratio as Sample D, however due to the larger sample volume; drying time increased yielding lower unconfined shear strength as compared to Sample D.

The relative shear strength of the treated tailings after 24 hours of air drying as compared to the MFT/sand ration is shown in FIG. 9. As can be seen, generally, the higher the ration of sand-to-MFT, the higher the value of shear strength.

### Remarks and Observations

The mixing comparison tests revealed that for treated AC-3 material, the ideal mixing ratio to achieve the highest shear strength in the shortest amount of time is 1 part treated MFT to 2 parts sand (Sample C). After 24 hours, this sample material was fairly pliable, yet firm enough to yield unconfined shear strength of approximately 75 kPa. After 96 hours, the same sample appeared fully dehydrated as did Samples B though G. For the same period of time, Sample A (MFT only) was slightly dehydrated after 24 hours but exhibited weak shear properties. After 96 hours, Sample A was extremely hard and had a solid rock-like feel.

The preferred final properties of the treated product will determine which amount of mixing with filler material will be used. It is clear that depending on the volume and mixing ratios, the dehydration times and shear strengths will vary. The producers may want a material that has a thinner or thicker consistency based on the amount of time and available equipment needed to place the treated material and the overall purpose of the material (fill, berm, roadbase, etc. . . . ).

The present invention also comprehends being able to selectively treat sections of the tailings pond/treatment cell as local requirements demand. In the first instance the tailings ponds tend to be vast in area and to facilitate the treatment the present invention contemplates creating smaller treatment areas by means of sheet piling or the like, or by creating pressure barriers around the treatment area. This can be used to divide the area of the pond up into smaller areas or cells to facilitate treatment. The sheet pile may also be used as an electrode in some cases.

Although the foregoing description has been made with respect to preferred embodiments of the present invention it will be understood by those skilled in the art that many variations and alterations are possible without departing from the broad spirit of the claims attached. Some of these variations have been discussed above and others will be apparent to those skilled in the art.

We claim:

1. A method of treating tailings having a combination of at least some water and clay particles, wherein at least some water molecules weakly bond to said clay particles to form a gel like fluid from which water does not readily separate, the method comprising the steps of:
applying alternating current to said tailings to change the properties of said tailings to reduce the weak bonding between the water and said clay particles so that water within the treated tailings is able to separate; and
allowing the water within said treated tailings to separate without further application of electricity.

2. The method of claim 1 in which allowing the water within said treated tailings to separate further comprises allowing the treated tailings to dry through evaporation.

3. The method of claim 1 further including the step of transporting said treated tailings to a site for further disposal.

4. The method of claim 1 in which applying alternating current to said tailings further comprises applying alternating current at a voltage gradient range of 1 to 5 V/cm for a total duration of 24 to 300 hours.

5. The method of claim 4 in which applying alternating current to said tailings further comprises applying alternating current at a voltage gradient range of 3 to 5 V/cm for a total duration of 24 to 48 hours.

6. The method of claim 5 in which applying alternating current to said tailings further comprises applying alternating current at about 4 V/cm.

7. The method of claim 1 in which applying alternating current further comprises applying alternating current at a frequency of 1-30 Hz.

8. The method of claim 7 in which applying alternating current further comprises applying alternating current at a frequency of 10-20 Hz.

9. The method of claim 1 further including the step of mixing a predetermined amount of filler material into said treated tailings prior to evaporative drying of said tailings to produce a desired shear strength for the processed material.

10. The method of claim 9 wherein said filler material is sand.

11. The method of claim 9 in which the desired shear strength is greater than 5 kilopascals.

12. The method of claim 1 further comprising:
applying direct current to the tailings during the application of alternating current to remove water from tailings during the treatment process.

13. A method of treating liquid tailings through the application of alternating current, comprising:
treating liquid tailings having gel properties with enough alternating current to disrupt the gel properties of the liquid tailings and to permit water to escape;
air drying the processed liquid tailings to produce a finished product in the form of a paste with a predetermined viscosity range.

14. The method as claimed in claim 13 wherein said paste has a viscosity of between 100,000 and 1,000,000 centipoise.

15. A method of treating tailings having a combination of at least some water and clay particles, wherein at least some water molecules weakly bonds to said clay particles to form a gel like fluid from which water does not readily evaporate, the method comprising the steps of:
treating the liquid tailings with alternating current further comprising applying alternating current to the liquid tailings at a voltage gradient range of 1 to 5 V/cm for a total duration of 24 to 300 hours.

16. The method of claim 15 further comprising:
transporting the liquid tailings to a separate drying location after treating the liquid tailings with alternating current; and
air drying the treated tailings at the separate drying location to form a finished product.

17. The method of claim 16 in which the finished product has a shear strength greater than 5 kilopascals.

18. The method of claim 17 in which the shear strength of the finished product is greater than 10 kilopascals.
